(19) United States
(12) Patent Application Publication
(10) Pub. No.: US 2011/0317812 A1
(43) Pub. Date: Dec. 29, 2011

(54) METHOD OF LOW ENERGY IMAGING IN THE PRESENCE OF HIGH ENERGY RADIATION

(76) Inventors: Mohamad Khairul Islam, Oakville (CA); Bernhard Dieter Norrlinger, Mississauga (CA); Jason R. Smale, Ottawa (CA); Robert K. Heaton, Toronto (CA); David A. Jaffray, Toronto (CA)

(21) Appl. No.: 13/254,646

(22) PCT Filed: Mar. 5, 2010
(86) PCT No.: PCT/CA10/00317

§ 371 Date: Sep. 2, 2011

Related U.S. Application Data
(60) Provisional application No. 61/157,738, filed on Mar. 5, 2009.

(51) Int. Cl. G01N 23/04; G01T 1/24; G01T 1/16

(52) U.S. Cl. 378/62; 250/395; 250/393; 250/370.08; 250/371

(57) ABSTRACT

An apparatus and method obtain an image of an object from a first radiation source in the presence of a second radiation source. The first radiation source is directed at a first side of the object while the second radiation source is directed at the second side of the object. At least one portion of the radiation is detected at the second side of the object. A first signal is produced based on the at least one portion of detected radiation. The first signal has a first radiation component and a second radiation component. At least one other portion of radiation at the second side of the object is filtered and then detected. A second signal is produced based on the detected filtered radiation. The second signal has at least one of a filtered first radiation component and a filtered second radiation component. Then a third signal is produced from the first and second signals. The third signal is a representation of a first radiation component.

### FIELD

Applicants' teachings relate to radiation imaging for verifying patient position in the presence of high energy radiation.

### INTRODUCTION

During the application of radiation therapy it is often desirable to accurately target a radiation beam at specific areas of a patient. In many cases, the desired target is in close proximity to normal tissues of the patient. In some cases, radiation imaging technology is used prior to the application of the therapeutic radiation to obtain information about the position of the desired target area. The imaging information may be obtained minutes before the application of the therapeutic radiation. It is generally assumed that the target area will not move significantly in the time between acquiring the images and the completion of the application of the therapeutic radiation.

### SUMMARY

The following summary and introduction is intended to introduce the reader to this specification but not to define any invention. One or more inventions may reside in a combination or sub-combination of the apparatus elements or method steps described below or in other parts of this document. The inventor does not waive or disclaim his rights to any invention or inventions disclosed in this specification merely by not describing such other invention or inventions in the claims.

Some embodiments relate to a method of obtaining an image of an object from a first radiation source in the presence of a second radiation source. The method may comprise: (a) directing the first radiation source at a first side of an object, while directing the second radiation source at the object; (b) detecting at least one portion of detected radiation at a second side of the object; (c) producing a first signal based on said at least one portion of detected radiation, the first signal having a first radiation component and a second radiation component; (d) filtering at least one other portion of detected radiation at the second side of the object; (e) after filtering, detecting said at least one other portion of detected radiation, to give detected filtered radiation; (f) producing a second signal based on the detected filtered radiation, the second signal having at least one of a filtered first radiation component and a filtered second radiation component; and (g) producing a third signal from the first and second signals, the third signal being a representation of a first radiation component.

Further embodiments relate to apparatus for obtaining an image of an object in the presence of an interfering radiation. In some embodiments, the apparatus may comprise: (a) an imaging radiation source for projecting imaging radiation through the object; (b) an imager; and (c) a processor coupled to the first and second imaging panels. In some embodiments, the imager comprises: (i) a first imaging panel, the first imaging panel being positioned to receive radiation directed through the object from the imaging radiation source, the first imaging panel produces a first signal based on the received radiation; (ii) a second imaging panel, the second imaging panel being positioned to receive radiation passing through the first imaging panel, the second imaging panel produces a second signal based on the received radiation; and (iii) a filter, the filter being positioned to filter radiation passing through the first imaging panel. In various embodiments, the processor is adapted to: (i) receive the first signal; (ii) receive the second signal; and (iii) produce a third signal based on the first and second signal, the third signal being a representation of a portion of the imaging radiation passing through the object.

Further embodiments relate to apparatus for obtaining an image of an object in the presence of an interfering radiation. In some embodiments, the apparatus may comprise: (a) an imaging radiation source for projecting imaging radiation through the object; (b) an imager; and (c) a processor coupled to the first and second imaging panels. In some embodiments, the imager comprises: (i an imaging panel, the imaging panel positioned to receive radiation directed through the object from the imaging radiation source, the imaging panel produces a first signal based on the received radiation; and (ii) a filter, the filter being moveable between a first position in which the filter is between the imaging panel and the imaging radiation source and a second position in which the filter exposes the imaging panel to the imaging radiation source; In various embodiments, the processor is adapted to: (i) receive the first signal; (ii) receive the second signal; and (iii) produce a third signal based on the first and second signal, the third signal being a representation of a portion of the imaging radiation passing through the object.

### DRAWINGS

For a better understanding of the described embodiments, and to show more clearly how they may be carried into effect, reference will now be made, by way of example, to the accompanying drawings, which illustrate aspects of the described embodiments and in which:

FIG. 1 is a block diagram of an imaging system according to various embodiments of Applicants' teachings;

FIG. 2A is a block diagram of the imaging system of FIG. 1 according to various embodiments;

FIG. 2B is a block diagram of the imager of FIG. 2A;

FIG. 3A is a block diagram of the imaging system of FIG. 1 according to various embodiments;

FIG. 3B is a block diagram of the imager of FIG. 3A;

FIG. 4 is a block diagram of an imaging system according to various embodiments of Applicants' teachings;

FIG. 5 is a block diagram of an imaging system according to various embodiments of Applicants' teachings; and

FIGS. 6A to 6D illustrate images obtained through the use of a method according to Applicants' teachings.

### DESCRIPTION OF VARIOUS EMBODIMENTS

Various apparatuses or methods will be described below to provide an example of an embodiment of each claimed invention. No embodiment described below limits any claimed invention and any claimed invention may cover apparatuses or methods that are not described below. The claimed inventions are not limited to apparatuses or methods having all of the features of any one apparatus or method described below or to features common to multiple or all of the apparatuses described below. It is possible that an apparatus or method described below is not an embodiment of any claimed invention. The applicants, inventors and owners reserve all rights in any invention disclosed in an apparatus or method described below that is not claimed in this document and do not abandon, disclaim or dedicate to the public any such invention by its disclosure in this document.

In recent years many advancements have been made in radiation therapy, including the development and clinical deployment of geometrical, functional and molecular imaging (CT, MRI, PET) for target definition, optimum treatment plan and delivery by intensity modulated radiation therapy (IMRT), and high resolution imaging to verify patient set up in treatment position using built-in kV x-ray imaging on medical linear accelerators. However, Applicants postulate that the next step in developing technology for radiation therapy is to work towards the next degree of precision in targeting by taking into account the organ motion during the treatment delivery and organ deformation due to treatment response. These techniques are referred to as image guided adaptive radiation therapy (IGART). However, Applicants have recognized that an important limitation in realizing high precision image guided radiation therapy is the assumption that the target position remains the same during subsequent treatment delivery. In known systems, there has been a temporal mismatch between imaging and dose delivery. Although it is known that certain organs can move due to various biological processes, it has been assumed that the target will remain at the same location as determined during imaging minutes before the dose delivery.

The built-in kilo-voltage (kV) X-ray imaging capabilities available with the modern linear accelerators allow acquisition of high-resolution and high contrast images for patient set up verification in two and three dimensions (2D/3D). However, as discussed above, the current practice of kV imaging and treatment delivery with mega-voltage (MV) beams is sequential rather than simultaneous; therefore, monitoring of patient positioning does not take place in real-time. The organs of interest (planning target volume and organ-at-risk) may move involuntarily and significantly during a treatment session (termed as intrafraction motion) due to breathing, heartbeat and other biological processes. Some of these motions may take place in an unpredictable manner and lead to errors in beam delivery. These limitations could be a critical issue in the cutting edge treatment modalities such as stereotactic body radiation therapy (SBRT) and hypo fractionated treatments that deliver a large dose of radiation in a single or a few fractions. The Applicants propose that the effectiveness and safety of these techniques as well as other high precision strategies, such as adaptive radiotherapy, can be improved through the acquisition of patient images simultaneous to the delivery of radiation treatment.

An impediment in simultaneous kV imaging is the presence of unwanted scatter generated in the patient during MV beam delivery. Specifically, relatively high intensity scatter from the treatment beam degrades the contrast of kV images substantially. To eliminate the effect of MV scatter on the kV images, two approaches can be considered: (a) interleave kV beam pulses between the MV pulses or (b) apply correction to the captured image for MV scatter contributions. The first option is not optimal due to inconsistent time scales between the therapy delivery system and the readout of the kV imaging panel. Therapy MV pulses are typically 3-4 micro seconds in length, separated by intervals of 2-5 milliseconds. The kV imaging panel typically requires acquisition and readout time of 100 milliseconds, implying that a hold-off of readout cycle would be necessary while delivering 20 to 50 MV pulses. This would increase the beam delivery time as well as potentially degrade the kV image. For scatter correction, two approaches could be considered: (i) use of scatter removing grids and (ii) subtracting of modeled scatter. A scatter reduction grid would pose many problems primarily due to higher mean energy of the MV scatter (−511 kV) and large magnitude of scatter signal. Subtracting a modeled scatter could be also problematic due to the large scatter signal; a small change in scatter condition could introduce a large amount of noise and image artifacts.

Various systems and methods according to Applicants' teachings disclosed herein provide for imaging to be performed simultaneously with treatment beam delivery. Some embodiments according to Applicants' teachings disclosed herein provide for imaging to be performed based on imaging radiation in the presence of higher energy interference radiation. In addition, as described herein, the systems and methods according to applicants' teachings overcome difficulties associated with degradation of the image due to the presence of higher energy radiation, which may for example be scatter from a treatment beam. In various embodiments, Applicants' teachings have various applications including but not limited to imaging for high precision radiation therapy.

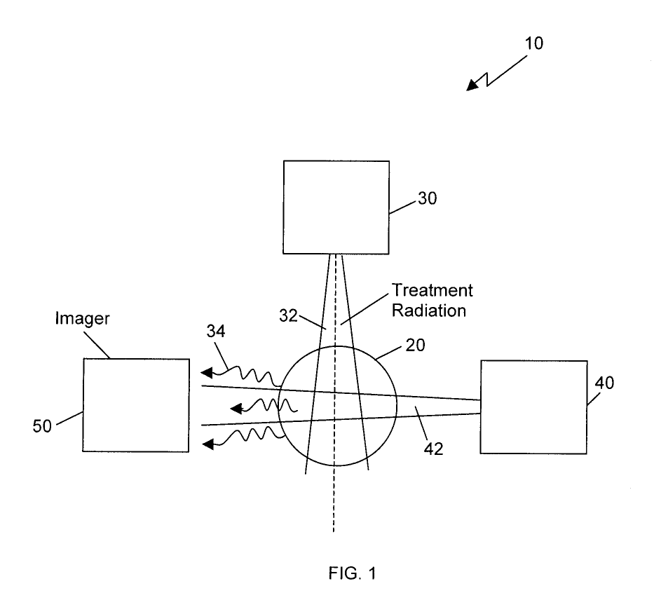

Reference is first made to FIG. 1, which illustrates a block diagram of an imaging system 10 according to various embodiments of Applicants' teachings. Imaging system 10 is used to monitor the position of internal organs of patient 20 during radiation treatment.

Radiation therapy source 30 is used to apply treatment radiation beam 32 to patient 20. It should be understood that radiation therapy source 30 can be any appropriate radiation source for delivering a radiation beam 32 to a patient. Accordingly, radiation beam 32 can comprise any appropriate radiation. Some scatter radiation 34 results from the interaction of radiation beam 32 with patient 20.

Imaging radiation source 40 is used to apply imaging radiation beam 42 to patient 20. It should be understood that imaging radiation source 40 can be any appropriate radiation source for delivering an imaging radiation beam 42. Accordingly, radiation beam 42 can comprise any appropriate radiation.

In various embodiments, imaging radiation source 40 produces a beam that is many times less powerful than the beam produced by radiation therapy source 30. In some embodiments, radiation therapy source 30 is a Mega-voltage (MV) therapy source and imaging source 40 is a Kilo-voltage (kV) X-ray imaging source. However, it should be understood that these are examples and are not intended to be limiting.

Imager 50 is used to detect radiation from patient 20 and to create an image of the internal organs of patient 20 and produce a signal or image. The terms signal and image will be used interchangeably herein. Specifically, it should be understood that when the term image is used herein, it is not necessary for an actual image to be created or displayed. Rather, a signal representing the image could be used. Imager 50 receives both the imaging radiation 42 as well as the scatter radiation 34. The scatter radiation 34 obscures imaging radiation 42 and can prevent an accurate image from being produced based on imaging radiation 42.

According to various embodiments of Applicants' teachings, imager 50 captures two types of images or signals. The second image is a filtered with respect to the first image. In some embodiments, this is accomplished by capturing the first image with an imaging panel and the second type of image with an imaging panel augmented by a filter. Thus, in various embodiments the first image comprises information from both sources of radiation; while, the second image comprises a greater component of one source of radiation depending on the characteristics of the filter.

In some embodiments, the filter is used to attenuate the radiation and therefore the second image is an attenuated version of the first image. In such embodiments, the second image will predominately comprise the more powerful source of information. As will be described in greater detail below, in various embodiments, signal processing is used to process the two images to remove the component resulting from the scatter radiation 34. Specifically, mathematical relationships can be established between the scatter (or the imaging radiation) captured in the second image. Therefore, a net imaging radiation image can be derived by utilizing the two images or signals from the two panels. This results in an image that is derived predominantly form the imaging radiation.

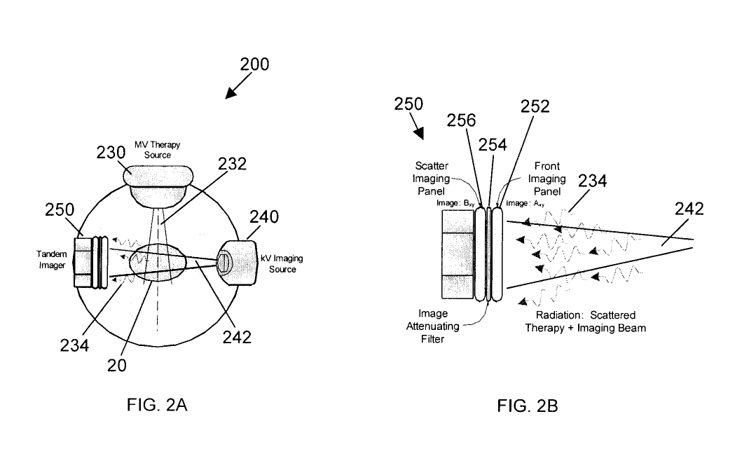

Reference is now made to FIG. 2A, which illustrates a schematic diagram of various embodiments of imaging system 200 according to Applicants' teachings. Imaging system 200 is used to monitor the position of the internal organs of patient 20 during radiation treatment.

Mega-voltage (MV) therapy source 230 is used to apply treatment radiation beam 232 to patient 20. The application of MV beam 232 to the patient results in the production of scatter radiation 234. Kilo-voltage (kV) X-ray imaging source 240 is used to apply imaging radiation beam 242 to patient 20.

Tandem imager 250 is used to capture radiation emanating from the direction patient 20 and to create an image of the internal organs of patient 20. Imager 250 receives both the imaging radiation 242 as well as the scatter radiation 234. The scatter radiation 234 obscures imaging radiation 242 and can prevent an accurate image from being produced based on imaging radiation 242. As explained above, in order to overcome this, two sets of images are produced. The second set of images is filtered and compared to the first set of images. The two sets of images are compared and used to produce a third set of images, where the third set of images is based on the imaging radiation with the scatter radiation substantially removed.

In some embodiments, tandem imager 250 will be mounted opposite the kV source, at a source to surface distance of 155 cm. It should be understood that this is an example only. In various other embodiments, other distance values are used. In addition, in some embodiments, the imaging field sizes up to 40 cm×40 cm will be utilized. In various other embodiments, other field sizes are utilized.

In various embodiments, tandem imager 250 includes a front imaging panel 252, an image attenuating filter 254, and a scatter imaging panel 256. Front imaging panel 252 is positioned facing patient 20 and in the path of radiation beam 242. Filter 254 is positioned behind panel 252. In addition, scatter imaging panel 256 is positioned behind filter 254. The front imaging panel detects the radiation and produces a first image A_{x,y} that has components of both the scatter radiation 234 and the imaging radiation 242. In some embodiments, both imaging panels 252 and 256 are amorphous silicon (aSi) imaging panels. In various other embodiments, other types of imaging panels are used.

Filter 254 is used to filter the radiation passing through panel 252. The scatter imaging panel 256 detects the filtered radiation and is used to produce a second image B_{x,y} that has a filtered scatter radiation component and a filtered imaging radiation component. In some embodiments, filter 254 is a photon energy filter and is designed to be positioned between imaging panels 254 and 256. In various embodiments, the filter will be a Thorius type filter and can be comprised of one or more types of material, which may include but are not limited to, aluminum copper, and tin. This type of filter is used to suppress noise due to the K shell characteristic radiation resulting from photoelectric interactions. In some embodiments, the filter heavily attenuates the kV beam radiation and in such embodiments, the second image B_{x,y} primarily comprises a scattered radiation component. In some embodiments, the filter nearly completely attenuates the kV beam.

In the embodiments illustrated in FIGS. 2A and 2B both images can be captured simultaneously. In order to accomplish this, in various embodiments, imaging system 200 includes a data acquisition system. The data acquisition system includes two frame grabbers. One frame grabber is used per imaging panel 252 and 256. The data acquisition system also includes inputs for synchronization signals and software for processing the information. The use of simultaneous image capture can avoid problems that would be associated with non-simultaneous image capture. Specifically, variation in pulse behaviors and quantum noise may introduce larger statistical noise when the images are not captured simultaneously.

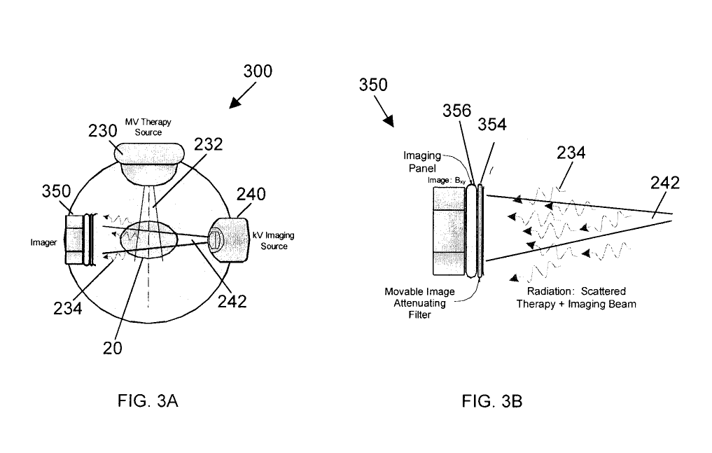

Reference is now made to FIGS. 3A and 3B, which illustrate a schematic diagram of various embodiments of imaging system 300 and an imager 350 respectively, according to Applicants' teachings. Imaging system 300 is similar to imaging system 200 except that the imager is different.

Imager 350 comprises a moveable image attenuating filter 354 and an imaging panel 350. In some embodiments, imaging panel 356 is an amorphous silicon (aSi) imaging panel. In various other embodiments, other types of imaging panels are used. Imaging panel 356 is positioned facing patient 20 and in the path of radiation beam 242. Filter 354 is moveable between a first position in which it covers imaging panel 356 and a second position in which it exposes imaging panel 356. Filter 354 can be moved between the first and second position by any appropriate mechanism.

Thus, panel 256 can be used to generate two sets of images. The first image A_{x,y} is produced when panel 256 is exposed. Image A_{x,y} has components of both the scatter radiation 234 and the imaging radiation 242. The second image B_{x,y} is produced when filter 354 covers panel 356. Image B_{x,y} comprises a filtered scatter radiation component and a filtered imaging radiation component. In some embodiments, the filter heavily attenuates the kV beam radiation and in such embodiments, the second image B_{x,y} primarily comprises a scattered radiation component. In some embodiments, the filter nearly completely attenuates the kV beam.

In various embodiments filter 354 can be cycled between the two positions in a rapid manner. Thus, in some embodiments, the two sets of images can be captured nearly simultaneously. In various embodiments, the speed of cycling between the two positions and capturing the two images is sufficient to avoid adverse affects associated with patient movement.

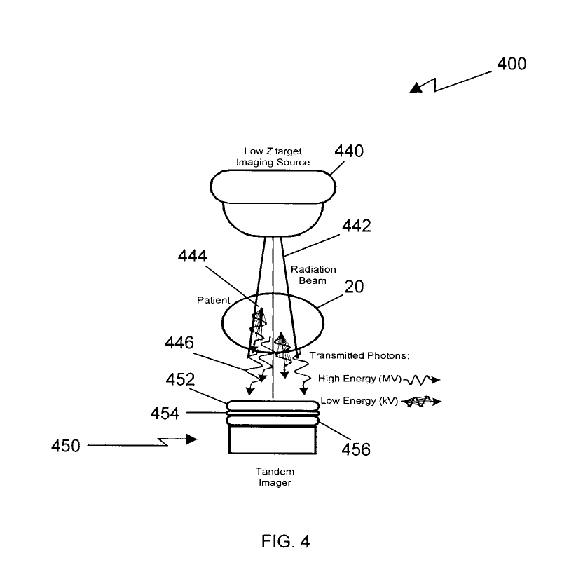

Reference is now made to FIG. 4, which illustrates a schematic diagram of an imaging system 400 according to various embodiments of Applicant's teachings. Imaging system 400 is used to monitor the position of internal organs of patient 20.

Radiation source 440 is used to apply radiation beam 442 to patient 20. It should be understood that imaging radiation source 440 can be any appropriate radiation source for delivering a radiation beam 442. Accordingly, radiation beam 442 can comprise any appropriate radiation.

In some embodiments, radiation source 440 is implemented by introducing a separate low-energy photon source inside the head of a radiation treatment unit. In such embodiments, radiation source 440 can be a low atomic number (Z) target based, low energy imaging linear accelerator. Imaging beam 442 is produced by directing a beam of electrons at the low atomic number target. The resulting beam 242 is comprised of high energy (e.g. MV) radiation components (i.e. high energy photons) 444 and low energy (e.g. kV) 446 radiation components (i.e. low energy photons).

Tandem imager 450 is used to capture radiation emanating from the direction of patient 20 and to create an image of the internal organs of patient 20. Imager 450 receives both the low energy radiation 446 as well as the high energy radiation 444. The high energy radiation 444 (produces low contrast image) obscures low energy radiation 446 and can prevent an accurate image from being produced based on low energy radiation 446. In order to overcome this, two sets of images are produced. The second set of images is filtered and compared to the first set of images. The two sets of images are compared and used to produce a third set of images, where the third set of images is based on the imaging radiation with the low contrast image substantially removed.

In some embodiments, tandem imager 450 will be mounted opposite the Low Z target imaging source, at a source to surface distance of, for example, 155 cm. It should be understood that this is an example only. In various other embodiments, other distance values are used. In addition, in some embodiments, the imaging field sizes up to 40 cm×40 cm will be utilized. In various other embodiments, other field sizes are utilized.

In various embodiments, tandem imager 450 includes a front imaging panel 452, an image attenuating filter 454, and a high energy imaging panel 456. Front imaging panel 452 is positioned facing patient 20 and in the path of radiation beam 442. Filter 454 is positioned behind panel 452. In addition, high energy imaging panel 456 is positioned behind filter 454. The front imaging panel detects the radiation and produces a first image A_{x,y} that has components of both the high energy radiation 444 and the low energy radiation 446. In some embodiments, both imaging panels 452 and 456 are amorphous silicon (aSi) imaging panels. In various other embodiments, other types of imaging panels are used.

Filter 454 is used to filter the radiation passing through panel 452. The high energy imaging panel 456 detects the filtered radiation and is used to produce a second image B_{x,y} that has a filtered high energy radiation component and a filtered low energy radiation component. In some embodiments, filter 454 is a photon energy filter and is designed to be positioned between imaging panels 454 and 456. In various embodiments, the filter will be a Thorius type filter and can be comprised of one or more types of material, which may include but are not limited to, aluminum copper, and tin. This type of filter is used to suppress noise due to the K shell characteristic radiation resulting from photoelectric interactions. In some embodiments, the filter heavily attenuates the low energy radiation and in such embodiments, the second image B_{x,y} primarily comprises a high energy radiation component. In some embodiments, the filter nearly completely attenuates the low energy radiation.

In the embodiments illustrated in FIG. 4 both images can be captured simultaneously. In order to accomplish this, in various embodiments, imaging system 400 includes a data acquisition system. The data acquisition system includes two frame grabbers. One frame grabber is used per imaging panel 452 and 456. The data acquisition system also includes inputs for synchronization signals and software for processing the information. The use of simultaneous image capture can avoid problems that would be associated with non-simultaneous image capture. Specifically, variation in pulse behaviors and quantum noise may introduce larger statistical noise when the images are not captured simultaneously.

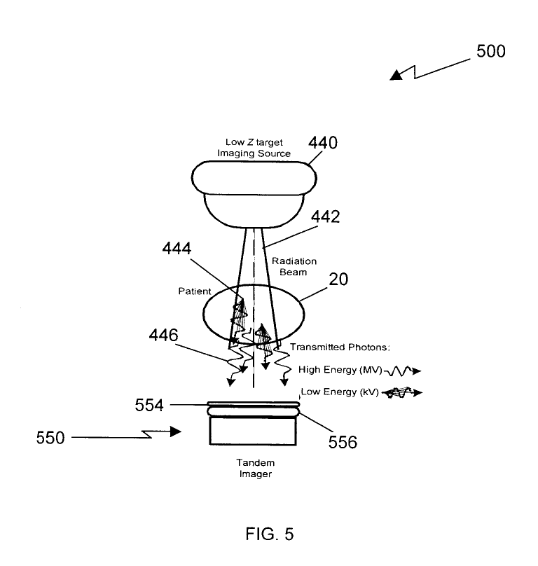

Reference is now made to FIG. 5, which illustrates a schematic diagram of various embodiments of imaging system 500, according to Applicants' teachings. Imaging system 500 is similar to imaging system 400 except that the imager is different.

Imager 550 comprises a moveable image attenuating filter 554 and an imaging panel 550. In some embodiments, imaging panel 556 is an amorphous silicon (aSi) imaging panel. In various other embodiments, other types of imaging panels are used. Imaging panel 556 is positioned facing patient 20 and in the path of radiation beam 442. Filter 554 is moveable between a first position in which it covers imaging panel 556 and a second position in which it exposes imaging panel 556. Filter 554 can be moved between the first and second position by any appropriate mechanism.

Thus, panel 556 can be used to generate two sets of images. The first image A_{x,y} is produced when panel 556 is exposed. Image A_{x,y} has components of both the high energy radiation 444 and the low energy radiation 442. The second image B_{x,y} is produced when filter 554 covers panel 556. Image B_{x,y} comprises a filtered high energy radiation component and a filtered low energy radiation component. In some embodiments, the filter heavily attenuates the low energy radiation and in such embodiments, the second image B_{x,y} primarily comprises a high energy radiation component. In some embodiments, the filter nearly completely attenuates the low energy component.

In various embodiments, filter 554 can be cycled between the two positions in a rapid manner. Thus, in some embodiments, the two sets of images can be captured nearly simultaneously. In various embodiments, the speed of cycling between the two positions and capturing the two images is sufficient to avoid adverse affects associated with patient movement.

Referring to FIGS. 2A to 5, for imaging systems 200, 300, 400, and 500, the images A_{x,y} and B_{x,y} can be described by the following equations:

A_{x,y}=I_{x,y}^{kV}+S_{x,y}^{MV} (1)

B_{x,y}=I_{x,y}^{kV}T_{x,y}^{kV}+S_{x,y}^{MV}T_{x,y}^{MV} (2)

Where I and S refer to the signals due to low energy (e.g. kV beam) radiation 242 or 446 and high energy radiation (e.g. MV) 444 or scatter 234 respectively, T is the transmission factor of the filter (254, 354, 454 or 554); the superscripts kV and MV on the transmission factor matrix T refer to kV beam 242 or and MV radiation 444 or scatter 234 respectively.

As an initial approximation, it can be assume that the factor T includes the respective beam transmission factor including the effect of scatter generated within the filter. In various embodiments, the T factors can be determined experimentally for various geometrical situations, such as field size, patient size (phantom size), and distance from the patient to the imager. Thus by using the two images, A and B, the above two equations can be solved for the desired image I_{x,y}^{kV}:

I_{x,y}^{kV}=(A_{x,y}T_{x,y}^{MV}−B_{x,y})/(T_{x,y}^{MV}−T_{x,y}^{kV}) (3)

Thus, Applicants' teachings allow for imaging to occur in real time simultaneously with the delivery of therapy radiation, where the therapeutic radiation is many times more powerful than the imaging radiation.

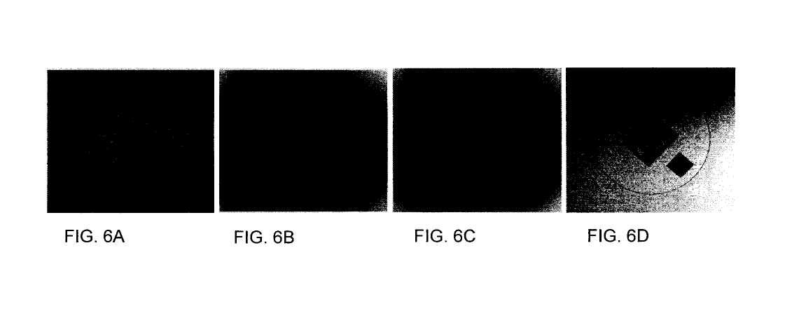

Applicants have performed tests to simulate and test various aspects of the disclosed system and method. Specifically, applicants have run tests using an Elekta (Crawley, United Kingdom) linear accelerator (Synergy) equipped with X-ray Volume Imaging (XVI) system. The XVI system includes a kV X-ray source and an aSi imaging panel mounted orthogonal to the MV beams. Images of a contrast phantom (Leeds Phantom® embedded in 14 cm of solid water phantom) were captured. Reference is now made to FIGS. 6A to 6D, which illustrate various that were captured during the simulation.

Applicants first captured a kV image, for use as the reference image, without the application of a MV beam. FIG. 6A illustrates the reference kV image of Leeds® (spatial and contrast resolution) phantom embedded in 14 cm solid water in a typical treatment geometry. The technique used in capturing these images were 120 kV, 2 mAs/frame.

Applicants then captured an image while simultaneously delivering kV and MV beams. More specifically, a 6 MV beam with a field size of 20 cm×20 cm was projected orthogonally to the kV beam. Heimann Imaging Software (HIS), distributed by Perkin Elmer (Waltham, Mass., USA) was utilized in capturing the image. FIG. 6B illustrates the kV image captured in the presence of the MV beam.

Applicants then captured images while a filter covered the imager. Various filters were tested. FIG. 6C illustrates an image captured when a 4 mm thick copper sheet was utilized as the filter. FIG. 6D illustrates a kV image extracted from the images illustrated in FIGS. 6B and 6C by scatter correction according to Applicants' teachings as described above by equation 3.

The average values of the transmission (T) of the copper filter for the 120 kV beam and the MV scatter (6 MV beam) were determined to be 4% and 46.5% respectively. For initial experiment these average values were used in equation 3, instead of a matrix of transmission factors T_{x,y}.

The above-described simulation does not exactly mimic imaging system 200, as described and illustrated above. Some differences include the fact that the image captured with a filter did not intercept the first panel and that the simulated images of the first and second panels were not captured simultaneously. Nonetheless, the above-described simulation has demonstrated the principle. In addition, the Applicants expect that the scatter corrected image will be improved significantly, when the raw images are captured simultaneously with an optimized filter and when an appropriate transmission matrix is used. Furthermore, the use of simultaneously captured images would reduce the quantum noise as well as the noise due to asynchronous acquisition of the two images used to derive the final image.

It should be understood that Applicants' teachings can be applied to various imaging technologies. For example, Applicants' teachings can be applied to correcting for the MV beam scatter and allow acquisition of high quality kV beams simultaneous with treatment beam delivery. These images can be utilized for 2D imaging as well as for the reconstruction of 3D cone beam CT images (CBCT). In particular, a high resolution kV CBCT can be obtained during the application of the advanced version of intensity modulated treatment techniques, VMAT® and RapidArc® treatment. In these techniques the gantry can be rotated continuously over the full or most part of the 360 degree rotation while delivering intensity modulated beams (modulation of MLC leaf motion and dose rate). Furthermore, Applicants' teachings can be applied to any situation in which acquisition of kV projection images is desired.

It should also be understood that although various embodiments have been described in relation to kV imaging in the presence of MV beam scatter, Applicants' teachings can be applied where other types of radiation are used. Thus, while the above description provides example embodiments, it will be appreciated that some features and/or functions are susceptible to modification and change without departing from the fair spirit and principles of operation of the described embodiments. Accordingly, what has been described is merely illustrative of the application of the described embodiments and numerous modifications and variations are possible in light of the above teachings.

1. A method of obtaining an image of an object from a first radiation source in the presence of a second radiation source, the method comprising:
a) directing the first radiation source at a first side of an object, while directing the second radiation source at the object;
b) detecting at least one portion of detected radiation at a second side of the object;
c) producing a first signal based on said at least one portion of detected radiation, the first signal having a first radiation component and a second radiation component;
d) filtering at least one other portion of detected radiation at the second side of the object;
e) after filtering, detecting said at least one other portion of detected radiation, to give detected filtered radiation;
f) producing a second signal based on the detected filtered radiation, the second signal having at least one of a filtered first radiation component and a filtered second radiation component; and
g) producing a third signal from the first and second signals, the third signal being a representation of a first radiation component.

2. The method of claim 1, wherein the second radiation source is a radiation therapy source, and the object is a patient.

3. The method of claim 1, wherein the filter is selected to provide different transmission characteristics for the first and second radiation, and step (g) comprises removing the effects of the second radiation components from the first and second signals, to give the third signal representative of the first radiation component.

4. The method of claim 3, wherein the third signal is produced according to the equation:
I_{x,y}^{kV}=(A_{x,y}T_{x,y}^{MV}−B_{x,y})/(T_{x,y}^{MV}−T_{x,y}^{kV})
where A_{x,y} is the first signal, B_{x,y} is the second signal, I_{x,y}^{kV} is the third signal, T_{x,y}^{kV} is a radiation transmission factor of the filter for the first radiation source, and T_{x,y}^{MV} is a radiation transmission factor of the filter for the second radiation source.

5. The method of claim 1, wherein the third signal can be produced in real time.

6. The method of claim 1, wherein the first and second signals are obtained simultaneously.

7. The method of claim 1, wherein the first and second signals are obtained sequentially.

8. The method of claim 1, wherein the first radiation source is a kV X-ray source and wherein the second radiation source is a MV radiation source.

9. The method of claim 1, wherein the first and second radiation sources are positioned to project radiation beams that are orthogonal to each other.

10. The method of claim 1, wherein the first and second radiation sources are positioned to project radiation beams that are aligned with each other.

11. The method of claim 1, wherein the first and second radiation sources are a low atomic number target based low energy imaging in Radiation Therapy Linear Accelerator.

12. The method of claim 1, wherein the radiation is detected using a imager comprising:
a) a first imaging panel, the first imaging panel being positioned to receive radiation directed through the object from the first radiation source;
b) a second imaging panel, the second imaging panel being positioned to receive radiation passing through the first imaging panel; and
c) a filter, the filter being positioned to filter radiation passing through the first imaging panel.

13. The method of claim 12, wherein the first and second imaging panels are aSi imaging panels.

14. The method of claim 12, wherein the filter substantially attenuates the radiation from the first radiation source.

15. The method of claim 12, wherein the first and second signals are produced simultaneously.

16. The method of claim 1, wherein the radiation is detected using a imager comprising:
a) an imaging panel, the imaging panel positioned to receive radiation directed through the object from the first radiation source;
b) a filter, the filter being moveable between a first position in which the filter is between the imaging panel and the first radiation source and a second position in which the filter exposes the imaging panel to the first radiation source.

17. The method of claim 16, wherein the imaging panel is an aSi imaging panel.

18. The method of claim 16, wherein the filter substantially attenuates the radiation from the first radiation source.

19. An apparatus for obtaining an image of an object in the presence of an interfering radiation, the apparatus comprising:
a) an imaging radiation source for projecting imaging radiation through the object;
b) an imager, the imager comprising;
i) a first imaging panel, the first imaging panel being positioned to receive radiation directed through the object from the imaging radiation source, the first imaging panel produces a first signal based on the received radiation;
ii) a second imaging panel, the second imaging panel being positioned to receive radiation passing through the first imaging panel, the second imaging panel produces a second signal based on the received radiation; and
iii) a filter, the filter being positioned to filter radiation passing through the first imaging panel;
c) a processor coupled to the first and second imaging panels, the processor is adapted to:
i) receive the first signal;
ii) receive the second signal; and
iii) produce a third signal based on the first and second signal, the third signal being a representation of a portion of the imaging radiation passing through the object.

20. The apparatus of claim 19, wherein the object is a patient.

21. The apparatus of 19, wherein the imaging radiation source is a kV X-ray source and wherein the interfering radiation is MV radiation.

22. The apparatus of claim 19, wherein the third signal is produced according to the equation:
I_{x,y}^{kV}=(A_{x,y}T_{x,y}^{MV}−B_{x,y})/(T_{x,y}^{MV}−T_{x,y}^{kV})
where A_{x,y} is the first signal, B_{x,y} is the second signal, I_{x,y}^{kV} is the third signal, T_{x,y}^{kV} is a radiation transmission factor of the filter for the imaging radiation source, and T_{x,y}^{MV} is a radiation transmission factor of the filter for the interfering radiation.

23. The apparatus of claim 19, wherein the first and second imaging panels are aSi imaging panels.

24. An apparatus for obtaining an image of an object in the presence of an interfering radiation, the apparatus comprising:
a) an imaging radiation source;
b) an imager, the imager comprising;
i) an imaging panel, the imaging panel positioned to receive radiation directed through the object from the imaging radiation source, the imaging panel produces a first signal based on the received radiation;
ii) a filter, the filter being moveable between a first position in which the filter is between the imaging panel and the imaging radiation source and a second position in which the filter exposes the imaging panel to the imaging radiation source;
c) a processor coupled to the imaging panel, the processor is adapted to:
i) receive the first signal;
ii) receive the second signal; and
iii) produce a third signal based on the first and second signal, the third signal being a representation of a portion of the imaging radiation passing through the object.

25. The apparatus of claim 24, wherein the object is a patient.

26. The apparatus of 24, wherein the imaging radiation source is a kV X-ray source and wherein the interfering radiation is MV radiation.

27. The apparatus of claim 24, wherein the wherein the third signal is produced according to the equation:
I_{x,y}^{kV}=(A_{x,y}T_{x,y}^{MV}−B_{x,y})/(T_{x,y}^{MV}−T_{x,y}^{kV})
where A_{x,y} is the first signal, B_{x,y} is the second signal, I_{x,y}^{kV} is the third signal, T_{x,y}^{kV} is a radiation transmission factor of the filter for the imaging radiation source, and T_{x,y}^{MV} is a radiation transmission factor of the filter for the interfering radiation.

28. The apparatus of claim 24, wherein the imaging panel is an aSi imaging panel.

29. The apparatus of claim 24, wherein the imaging radiation source is a low atomic number target based low energy imaging in Radiation Therapy Linear Accelerator.

30. The apparatus of claim 29, wherein the imaging radiation source produces a beam having a high energy component and a low energy component.

31. The apparatus of claim 30, wherein the high energy component generates the interfering radiation.

32. The apparatus of claim 24, including a second radiation source, spatially separate from said imaging radiation source, for producing a high energy beam.

33. The apparatus of claim 19, wherein the imaging radiation source is a low atomic number target based low energy imaging in Radiation Therapy Linear Accelerator.

34. The apparatus of claim 33, wherein the imaging radiation source produces a beam having a high energy component and a low energy component.

35. The apparatus of claim 34, wherein the high energy component generates the interfering radiation.

36. The apparatus of claim 19, including a second radiation source, spatially separate from said imaging radiation source, for producing a high energy beam.
